(19) United States
(12) Patent Application Publication
(10) Pub. No.: US 2024/0034262 A1
(43) Pub. Date: Feb. 1, 2024

(54) INSTRUMENT PANEL AIRBAG ASSEMBLY

(71) Applicant: NISSAN NORTH AMERICA, INC., Franklin, TN (US)

(72) Inventors: Brian DOWNEY, Westland, MI (US); Ramakrishna CHUNDURI, Troy, MI (US)

(21) Appl. No.: 17/877,856

(22) Filed: Jul. 29, 2022

(51) Int. Cl. B60R 21/205; B60R 21/215

(52) U.S. Cl. CPC B60R 21/205; B60R 21/215; B60R 2021/21512

(57) ABSTRACT

An instrument panel defines an upper surface and a lower surface. An airbag device has an inflatable portion and is installed to the instrument panel below and spaced apart from the lower surface. A panel is installed to the lower surface of the instrument panel above the airbag. The panel has an opening that is at least partially covered by a first door, a second door and a third door located along the lower surface of the instrument panel prior to deployment of the airbag. In response to deployment of the airbag, the inflatable portion pushes the first, second and the third doors upward against the instrument panel with the first door pivoting about a first hinge that extends in a vehicle lateral direction, and at least one of the second door and the third door pivoting about a second hinge that extends in a vehicle longitudinal direction.

### BACKGROUND

### Technical Field

The present disclosure generally relates to an instrument panel airbag assembly. More specifically, the present disclosure relates to an instrument panel airbag assembly that includes a chute that channels movement of an inflatable portion of an airbag device during deployment upward pressing against three separate doors at the top of chute causing the doors to open.

### Background Information

Airbag devices are installed at various locations within a vehicle including the instrument panel (also referred to as a dashboard) of the vehicle. When an airbag device within an instrument panel is deployed, the visible layer(s) of the instrument panel are intentionally torn making a pathway for the expanding inflatable portion of the airbag device.

### SUMMARY

One object of the present disclosure is to provide an instrument panel and an airbag device with a chute that includes a plurality of doors covering an airbag opening of the chute prior to deployment of the airbag device, and during deployment of the airbag device the doors pivot in predetermined directions tearing adjacent areas of the instrument panel thereby directing movement of expansion of an inflatable portion of the airbag device.

In view of the state of the known technology, one aspect of the present disclosure is to provide an instrument panel airbag assembly with an instrument panel, an airbag device and a panel. The instrument panel has a portion thereof that defines an upper surface of the instrument panel, the portion extending from the windscreen rearward. A lower surface of the portion of the instrument panel is defined beneath the portion of the instrument panel opposite the upper surface. The airbag device is installed to the instrument panel below and spaced apart from the lower surface, the airbag device having an inflatable portion. The panel is installed to the lower surface of the instrument panel above the airbag, the panel having an opening that is at least partially covered by a first door, a second door and a third door that are located along the lower surface of the instrument panel prior to deployment of the airbag, and in response to deployment of the airbag, the inflatable portion of the airbag pushes the first door, the second door and the third door upward against the instrument panel. During deployment, the first door pivoting about a first hinge that extends in a vehicle lateral direction, and at least one of the second door and the third door pivoting about a second hinge that extends in a vehicle longitudinal direction.

### BRIEF DESCRIPTION OF THE DRAWINGS

Referring now to the attached drawings which form a part of this original disclosure:

FIG. 1 is a perspective view of a portion of an instrument panel of a vehicle that includes an airbag device and a chute in accordance with a first embodiment;

FIG. 2 is another perspective view of the portion of the instrument panel of the vehicle showing details of the airbag device and the chute in accordance with the first embodiment;

FIG. 3 is a perspective view of the chute removed from the instrument panel showing a panel with an airbag opening, an airbag directing tunnel, a first door, a second door and a third door, with the first, second and third doors shown in an undeployed orientation in accordance with the first embodiment;

FIG. 4 is a cross-sectional view the portion of the instrument panel and the second and third doors of the chute taken along the line 4-4 in FIG. 2, showing a recessed tear area of the instrument panel and a gap between the second door and the third door in accordance with the first embodiment;

FIG. 5 is a cross-sectional view the portion of the instrument panel and the first and second doors of the chute taken along the line 5-5 in FIG. 2, showing another recessed tear area of the instrument panel and a gap between the first door and the second door in accordance with the first embodiment;

FIG. 6 is a cross-sectional view the portion of the instrument panel and the chute taken also along the line 4-4 in FIG. 2, showing the airbag device attached to flanges of the instrument pane, the recessed tear area of the instrument panel and the gap between the first door and the second door in accordance with the first embodiment;

FIG. 7 is another perspective view of the chute similar to FIG. 3 showing the first door, the second door and the third door being moved by the deploying airbag, the first, second and third doors being opened part way in an intermediate deployed orientation in accordance with the first embodiment;

FIG. 8 is another cross-sectional view of the chute similar to FIG. 6 showing the first door, the second door and the third door being moved by the deploying airbag, the first, second and third doors being opened part way in the intermediate deployed orientation in accordance with the first embodiment;

FIG. 9 is a top view of the chute showing the first, second and third doors in the non-deployed orientation in accordance with the first embodiment;

FIG. 10 is another top view of the chute showing the first, second and third doors in the intermediate deployed orientation in accordance with the first embodiment;

FIG. 11 is a top a schematic view of the portion of the instrument panel showing in phantom the panel of the chute along with the gaps between adjacent edges of the first, second and third doors, and showing the recessed tear areas being aligned with the gaps and showing that the second door is longer than the third door in accordance with the first embodiment; and

FIG. 12 is another top a schematic view of the portion of the instrument panel showing in phantom the panel of the chute along with the gaps between adjacent edges of the first, second and third doors, and showing the recessed tear areas being aligned with the gaps and showing that the second door and the third door are equal in length in accordance with a second embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

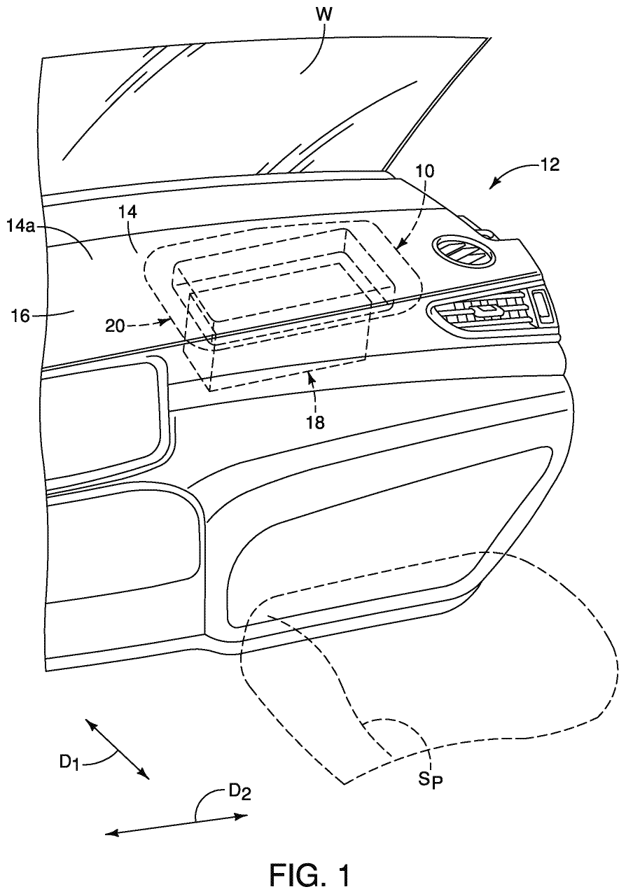

Referring initially to FIG. 1, an instrument panel airbag assembly 10 of a vehicle 12 is illustrated in accordance with a first embodiment. The instrument panel airbag assembly 10 includes a portion 14 of an instrument panel 16, an airbag device 18 and a chute 20.

The instrument panel 16 includes conventional vehicle gauges and controls (not shown) forward of a vehicle operator's seat (not shown). The instrument panel 16 also includes the portion 14 forward of a passenger's front seat S_{P} and further includes the airbag device 18 and the chute 20.

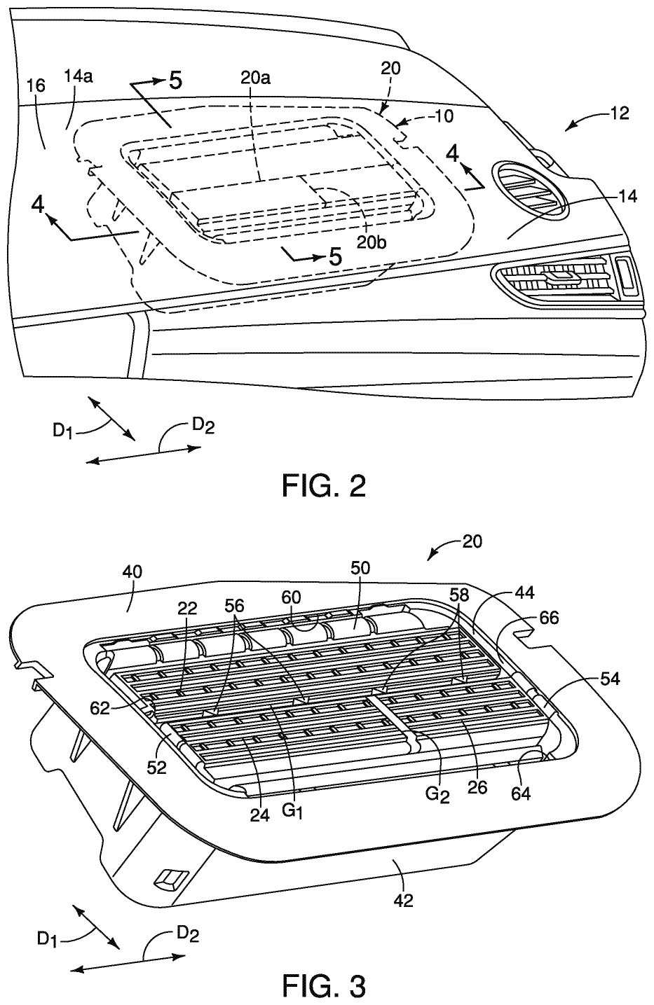

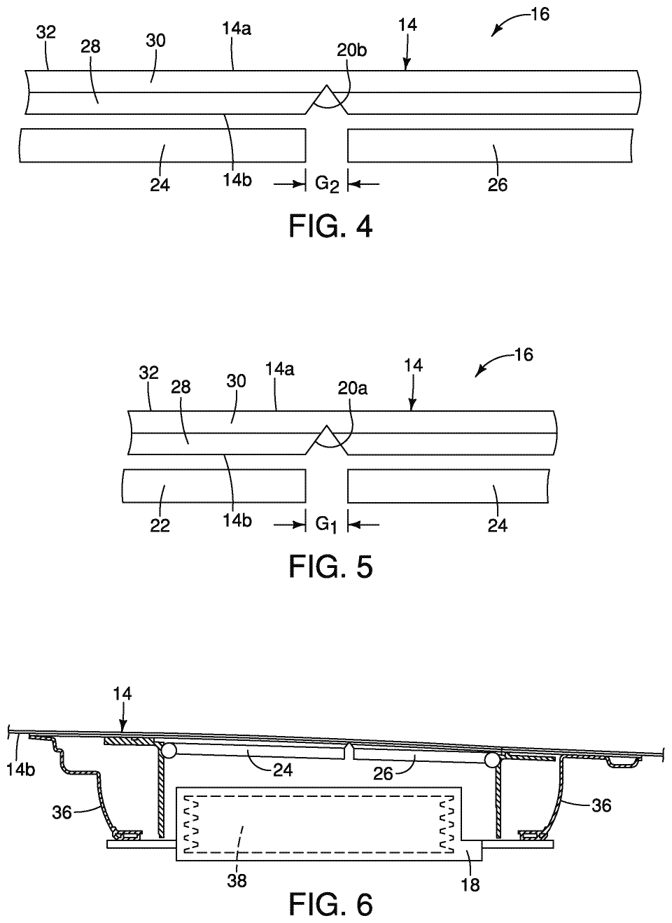

The portion 14 of the instrument panel 16 defines an upper surface 14a that is inclined with respect to horizontal, sloping downward and rearward toward the passenger's front seat S_{P} from a windscreen W of the vehicle 12. The portion 14 also defines a lower surface 14b (see FIGS. 4, 5 and 6) defined beneath the portion 14 of the instrument panel 16 opposite the upper surface 14a. As shown in FIGS. 2 and 4-6, the lower surface 16b includes recessed tear areas 20a and 20b located along portions of the lower surface 14a at locations corresponding to gaps G₁ and G₂ between adjacent edges of a first door 22, a second door 24 and a third door 26 of the chute 18. The tear areas 20a and 20b are dimensioned and shaped to tear in response to deployment of the airbag device 18, as described in greater detail below.

The portion 12 of the instrument panel 14 is multilayered. Specifically, the portion 12 includes a backing panel 28, a foam layer 30 and a skin 32. The backing panel 28 is shaped and dimensioned to define the overall design of the instrument panel 16. The foam layer 30 overlays the backing panel 28 and provides the instrument panel 16 with a soft feel with some cushioning provided by the foam layer 30.

More specifically, the foam layer 30 is compressible with the skin 32 overlaying the foam layer 30. The skin 32 includes a decorative look that can include a textured leather appearance and feel, a textile feel, or other appearance and feel to the touch. Further, the skin 32 can be a layer of leather or faux leather, depending upon the overall design of the vehicle 12 and its interior.

The backing panel 28 defines the lower surface 14b and the skin 32 defines the upper surface 14a of the instrument panel 16. The lower surface 14b of the backing panel 28 further includes the recessed tear areas 20a and 20b. The recessed tear areas 20a and 20b are dimensioned and shaped to tear upon deployment of the airbag device 18. More specifically, at least the hacking panel 28 includes the recessed tear areas 20a and 20b. As in the depicted embodiment, the recessed tear areas 20a and 20b have an inverted V-shape such that the backing panel 28 has a reduced thickness at the recessed tear areas 20a and 20_{b}. However, it should be understood from the drawings and the description that the recessed tear areas 20a and 20b can be produced with any of a variety of shapes and manufactured using any of a variety of methods. For example, the recessed tear areas 20a and 20b can have a curved shape or can have a rectangularly shaped area of reduced thickness of the backing panel 28 and is not limited to an inverted V-shape. The purpose and function of the recessed tear areas 20a and 20b is described in greater detail below.

The airbag device 18 is installed to flanges 36 of the instrument panel 16 below and spaced apart from the lower surface 14b. The airbag device 18 includes an inflatable portion 38 that is also described in greater detail below.

A description of the chute 20 is now provided with reference to FIGS. 3-10. The chute 20 includes an attachment panel 40, an airbag directing tunnel 42 (a chute 42), the first door 22, the second door 24 and the third door 26.

The attachment panel 40 (also referred to as the lower panel 40, rigid panel 40 or simply the panel 40) includes an airbag directing tunnel 42 (also referred to as the chute structure 42). The panel 40 defines an opening 44 with the airbag directing tunnel 42 extending downward from the panel 40 and surrounding the airbag directing tunnel 42.

The panel 40 is installed to the lower surface 14b of the backing panel 28 above the airbag device 18. As depicted in FIGS. 6 and 8, a portion of the airbag device 18 can extend upward into the airbag directing tunnel 42.

The opening 44 is at least partially covered by the first door 22, the second door 24 and the third door 26. The first door 22, the second door 24 and the third door 26 are attached to the panel 40 via first, second and third hinges 50, 52 and 54. More specifically, the first door 22 pivots about the first hinge 50, the second door 24 pivoting about the second hinge 52 and the third door 26 pivots about the third hinge 54.

The first, second and third hinges 50, 52 and 54 are preferably created during a plastic or resin/polymer molding process that includes molding the panel 40, the airbag directing tunnel 42, the first, second and third hinges 50, 52 and 54 and the first, second and third doors 22, 24 and 26 together as a single element. However, it should be understood from the drawings and the description herein that the panel 40, the airbag directing tunnel 42, the first, second and third hinges 50, 52 and 54 and the first, second and third doors 22, 24 and 26 can be separate elements assembled to define the chute 20. The first, second and third hinges 50, 52 and 54 do not need to be mechanical hinges. Rather, the first, second and third hinges 50, 52 and 54 are living hinges in that they are made of the same materials as the panel 40, the first door 22, the second door 24 and the third door 26, but have a reduced thickness as compared to the thickness of the panel 40, the first door 22, the second door 24 and the third door 26.

When the chute 20 is installed to the portion 14 of the instrument panel 16, the panel 40 is fixed to the lower surface 14b of the backing panel 28 of the instrument panel 16 by, for example, laser welding, adhesive material, and/or mechanical fasteners. With the airbag device 18 in an undeployed condition, as shown in FIGS. 1 and 6, the first door 22, the second door 24 and the third door 26 are positioned immediately under and preferably contacting the lower surface 14b of the backing panel 28 of the instrument panel 16.

As shown in FIG. 3 with the airbag device 18 in an undeployed condition, the first door 22 and the third door 26 are held together by bridging portions 56. Similarly, the second door 24 and the third door 26 are held together by bridging portions 58. Upon deployment of the airbag device 18, the bridging portions 56 and 58 are broken so that the first, second and third doors 22, 24 and 26 can open, as described further below.

The opening 44 in the panel 40 of the chute 20 defines a first edge 60, a second edge 62, a third edge 64 and a fourth edge 66. The first edge 60 and third edge 64 are opposite and parallel to one another. The second edge 62 and the fourth edge 66 are opposite and parallel to one another. Further, the second and fourth edges 62 and 66 extend between corresponding opposite ends of the first edge 60 and the third edge 64. The first hinge 50 connects the first door 22 to the first edge 60. The second hinge 52 connects the second door 24 to the second edge 62 and the third hinge 54 connects the third door 26 to the fourth edge 66.

In the depicted embodiment, the second hinge 52 and the third hinge 54 extend in directions that are parallel to one another. The first hinge 50 extends in a direction that is perpendicular to the second hinge 52 and the third hinge 52. More specifically, the second hinge 52 and the third hinge 54 extend in direction parallel to a vehicle longitudinal direction D₁, and the first hinge 50 extends in a vehicle lateral direction as shown in FIGS. 1-2 and 7-8. It should be understood from the drawings and the description herein that the vehicle lateral direction D₂ is perpendicular to the vehicle longitudinal direction D₁.

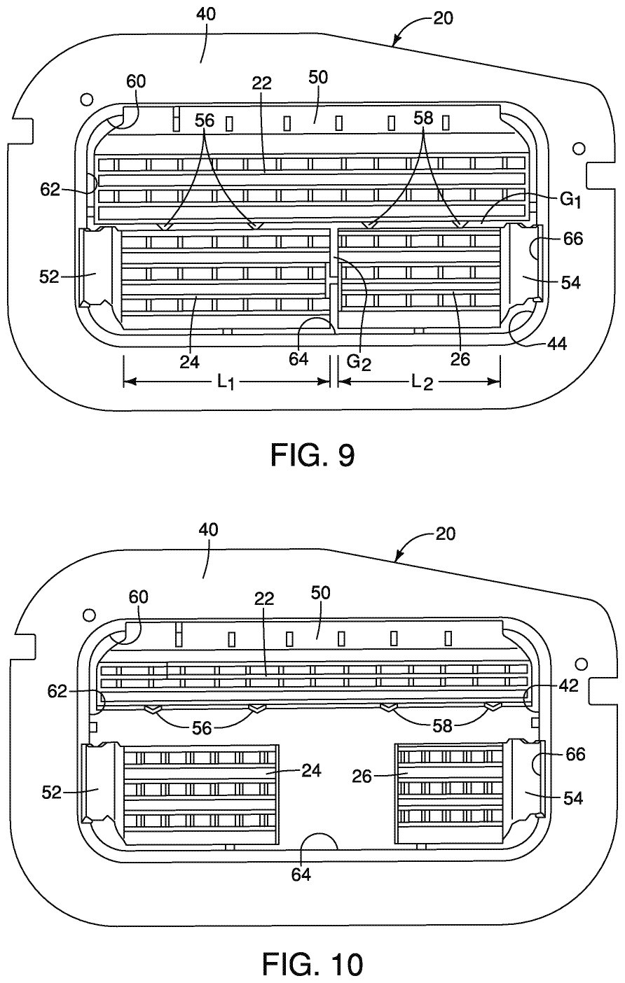

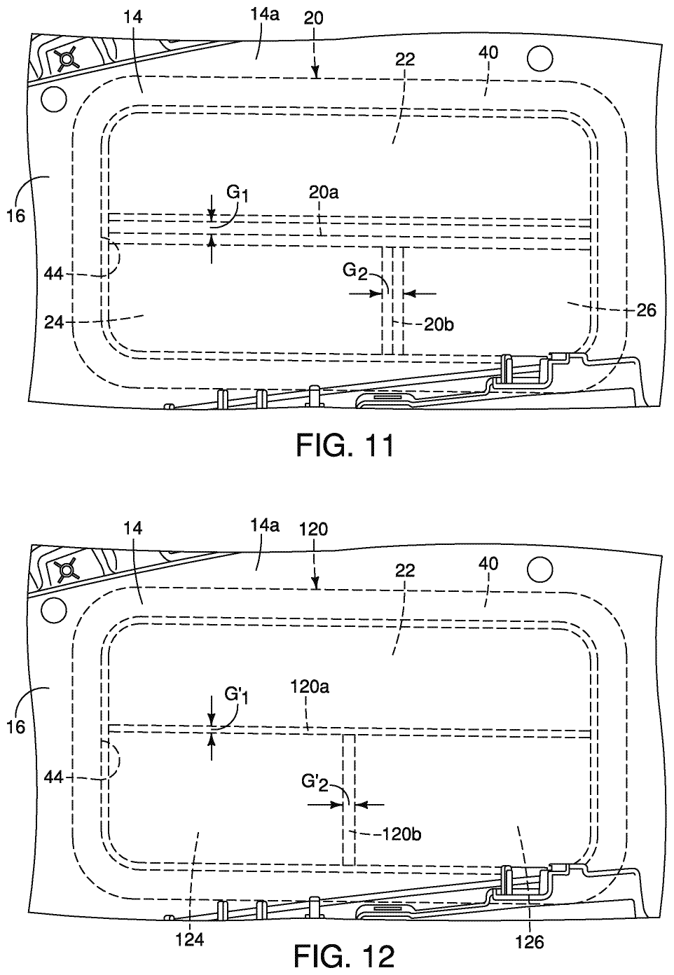

As shown in FIG. 9, the second door 24 has a first overall length L₁ measured in the vehicle lateral direction D₂ and the third door 26 has a second overall length L₂, measured in the vehicle lateral direction D₂. The first overall length L₁ is greater than the second overall length L₂.

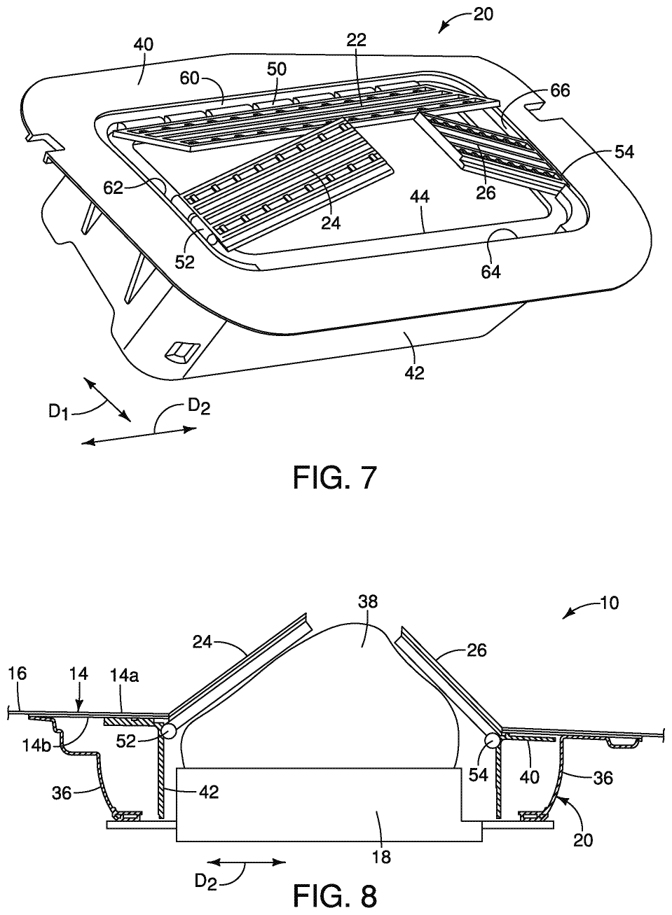

In response to deployment of the airbag device 18, the inflatable portion 38 of the airbag device 18 almost instantly inflates filling the space within the airbag directing tunnel 42 thereby pushing the first door 22, the second door 24 and the third door 26 upward. The force generated by the inflation of the inflatable portion 38 further presses the first door 22, the second door 24 and the third door 26 against the backing panel 28 tearing the recessed tear areas 20a and 20b. Thereafter, the first door 22 pivots about the first hinge 50, the second door 24 pivots about the second hinge 52 and the third door 26 pivots about the third hinge 54 such that the first, second and third doors 22, 24 and 26, allowing the inflatable portion 38 to come, upward through the opening 44 in the attachment panel 40, as shown in FIGS. 7 and 8. Thereafter, the inflatable portion 38 completely fills possibly contacting the windscreen W and filling the space between the windscreen W and area forward of the passenger's front seat S_{P}.

As is well known, upon deployment of the airbag device 18, the inflatable portion 38 rapidly expands in a matter of milliseconds, typically in response to, for example, an impact event. The tear areas 20a and 20b are dimensioned and shaped to tear along the areas of the gaps G₁ and G₂ defined between adjacent edges of the first, second and third doors 22, 24 and 26.

Since the second and third doors 24 and 26 open laterally outward as they pivot about the second and third hinges 52 and 54 in opposing lateral directions (corresponding to the vehicle lateral direction D₂) minimizing the reach of the second and third hinges 52 and 54 once the inflatable portion 38 is fully inflated.

When the inflatable portion 38 of the airbag device 18 deploys opening the first door 22, the second door 24 and the third door 26, the first, second and third hinges 50, 52 and 54 basically bend thereby acting as hinges. The first, second and third hinges 50, 52 and 54 have a thickness that is much less than the thickness of the panel 40 the first door 22, the second door 24 and the third door 26 allowing for bending. Further, the bridges 56 and 58 are also formed with a thickness that is much less than the thickness of the panel 40, the first door 22, the second door 24 and the third door 26. Consequently, the bridging portions 56 and 58 easily break in response to the deployment of the inflatable portion 38 of the airbag device 18

The airbag device 18 is a conventional mechanism well known in the art. Therefore, no further description of the airbag device 1$ is provided for the sake of brevity.

### Second Embodiment

Referring now to FIG. 12 a chute 120 in accordance with a second embodiment will now be explained. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity. The parts of the second embodiment that differ from the parts of the first embodiment will be indicated with a single prime (′).

The chute 120 includes the first door 22 and the attachment panel 40, as described above with respect to the first embodiment. However, in the second embodiment, the second doors 24 and 26 of the first embodiment have been replaced with a second door 124 and a third door 126. The second and third doors 124 and 126 have the same overall length and are spaced apart from the first door 22 defining a gap G′₁ therebetween, as shown in FIG. 12. Further, the second door 124 and the third door 126 are spaced part from one another defining a gap G′₂ therebetween. The location of the gap G′₂ is determined by the relative lengths of the second door 124 and the third door 126.

In the first embodiment, the second door 24 and the third door 26 are not the same length. Therefore, the gap G₂ is not centered relative to the opening 44. However, the gap G₂ of the first embodiment is preferably located along a line that passes through a center of the passenger's front seat S_{P} where the line is also parallel to the vehicle longitudinal direction D₁.

In the second embodiment, the gap G″2 is centered relative to the opening 44 and the second door 124 and the third door 126 of the second embodiment are the same length. Further, the gap G′₂ is preferably aligned with a center line extending through the passenger's front seat (not shown in FIG. 9) where that line is also parallel to the vehicle longitudinal direction D₁.

The various vehicle features and structures other than the instrument panel airbag assembly 10, are conventional components that are well known in the art. Since the vehicle features and structures are well known in the art, these structures will not be discussed or illustrated in detail herein. Rather, it will be apparent to those skilled in the art from this disclosure that the components can be any type of structure and/or programming that can be used to carry out the present invention.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiments, the following directional terms “forward”, “rearward”, “above”, “downward”, “vertical”, “horizontal”, “below” and “transverse” as well as any other similar directional terms refer to those directions of a vehicle equipped with the instrument panel airbag assembly 10. Accordingly, these terms, as utilized to describe the present invention should be interpreted relative to a vehicle equipped with the instrument panel airbag assembly 10.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims, For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

1. An instrument panel airbag assembly, comprising:
an instrument panel having a portion thereof that defines an upper surface of the instrument panel, the portion extending from a windscreen rearward with a lower surface defined beneath the portion of the instrument panel opposite the upper surface;
an airbag device installed to the instrument panel below and spaced apart from the lower surface, the airbag device having an inflatable portion; and
a chute including a panel that is installed to the lower surface of the portion of the instrument panel above the airbag device, the panel having an opening, the chute having a first door, a second door and a third door that at least partially cover the opening when in an undeployed condition, the first door, the second door and the third door being located along the lower surface of the portion of the instrument panel prior to deployment of the airbag device and in an undeployed condition a gap is defined between the first door and the second door, another gap defined between the first door and the third door with a portion of each of the gaps being interrupted by a first bridging portion that extends between the first door and the second door and a second bridging portion that extends between the first door and the third door, the first bridging portion being spaced apart from the second bridging portion, the first door, the second door and the third door being spaced apart from the lower surface of the portion of the instrument panel in the undeployed condition, and in response to deployment of the airbag device, the inflatable portion of the airbag device pushes the first door, the second door and the third door upward against the portion of the instrument panel with the first door pivoting about a first hinge that extends in a vehicle lateral direction breaking the first and second bridging portions, and at least one of the second door and the third door pivoting about a second hinge that extends in a vehicle longitudinal direction.

2. The instrument panel airbag assembly according to claim 1, wherein
the chute has an airbag directing tunnel that extends downward from the panel surrounding the opening, with an upper portion of the airbag device being disposed within the airbag directing tunnel and in response to deployment of the airbag device the shape and dimensions of the airbag directing tunnel directs the inflatable portion of the airbag device upward against the first, second and third doors and the lower surface of the portion of the instrument panel.

3. The instrument panel airbag assembly according to claim 1, wherein
the lower surface of the portion of the instrument panel includes recessed tear areas located along portions of the lower surface corresponding to gaps between adjacent edges of the first door, the second door and the third door.

4. The instrument panel airbag assembly according to claim 3, wherein
the tear areas are dimensioned and shaped to tear in response to deployment of the airbag device as the first, second and third doors are pushed upward.

5. The instrument panel airbag assembly according to claim 1, wherein
the instrument panel includes a skin, a foam layer and a backing panel, the foam layer being compressible with the skin overlaying the foam layer, the foam layer overlaying the backing panel.

6. The instrument panel airbag assembly according to claim 5, wherein
the backing panel defines the lower surface of the instrument panel and includes recessed tear areas located along portions of the lower surface corresponding to the gaps between adjacent edges of the first door, the second door and the third door.

7. The instrument panel airbag assembly according to claim 6, wherein
the tear areas are dimensioned and shaped to tear in response to deployment of the airbag device as the first, second and third doors are pushed upward.

8. The instrument panel airbag assembly according to claim 1, wherein
the vehicle lateral direction is perpendicular to the vehicle longitudinal direction.

9. The instrument panel airbag assembly according to claim 1, wherein
the opening of the panel defines a first edge, a second edge, a third edge and a fourth edge with the first edge and third edge being opposite one another, the second edge and the fourth edge being opposite one another, the second and fourth edges extending between corresponding opposite ends of the first edge and the third edge, and
the first hinge connects the first door to the first edge, the second hinge connects the second door to the second edge and a third hinge connects the third door to the fourth edge.

10. The instrument panel airbag assembly according to claim 9, wherein
the second hinge and the third hinge extend in directions that are parallel to one another.

11. The instrument panel airbag assembly according to claim 10, wherein
the first hinge extends in a direction that is perpendicular to the second hinge and the third hinge.

12. The instrument panel airbag assembly according to claim 9, wherein
the second door has a first overall length measured in the vehicle lateral direction and the third door has a second overall length measured in the vehicle lateral direction, the first overall length being greater than the second overall length.

13. The instrument panel airbag assembly according to claim 9, wherein
the second door has a first overall length measured in the vehicle lateral direction and the third door has a second overall length measured in the vehicle lateral direction, the first overall length being equal to the second overall length.

14. The instrument panel airbag assembly according to claim 1, wherein
the second door has a first overall length measured in the vehicle lateral direction and the third door has a second overall length measured in the vehicle lateral direction, the first overall length being greater than the second overall length.

15. The instrument panel airbag assembly according to claim 1, wherein
the second door has a first overall length measured in the vehicle lateral direction and the third door has a second overall length measured in the vehicle lateral direction, the first overall length being equal to the second overall length.

16. The instrument panel airbag assembly according to claim 1, wherein
the second hinge and the third hinge extend in directions that are parallel to one another.

17. The instrument panel airbag assembly according to claim 16, wherein
the first hinge extends in a direction that is perpendicular to the second hinge and the third hinge.

18. The instrument panel airbag assembly according to claim 16, wherein
each of the first door, the second door and the third door include ribs that extend along upper surfaces of each of the first door, the second door and the third door.
